(19) United States
(12) Patent Application Publication
(10) Pub. No.: US 2018/0273750 A1
(43) Pub. Date: Sep. 27, 2018

(54) Polycarbonate Resin Composition and Molded Product Produced From Same

(71) Applicant: LOTTE ADVANCED MATERIALS CO., LTD., Yeosu-si (KR)

(72) Inventors: Eun Byul LEE, Uiwang-si (KR); Jong Chan HUR, Uiwang-si (KR); O Sung KWON, Uiwang-si (KR); Jun Ho CHI, Uiwang-si (KR)

(21) Appl. No.: 15/763,894

(22) PCT Filed: Sep. 29, 2016
(86) PCT No.: PCT/KR2016/010873

§ 371 Date: Mar. 28, 2018

(30) Foreign Application Priority Data
Sep. 30, 2015 (KR) 10-2015-0138245

(51) Int. Cl. C08L 69/00; C08J 5/00

(52) U.S. Cl. CPC C08L 69/00; C08J 2491/06; C08J 2369/00; C08J 5/00

(57) ABSTRACT

A polycarbonate resin composition of the present invention comprises: a polycarbonate resin; and a release agent containing a fatty acid ester compound and paraffin wax, wherein the fatty acid ester compound and the paraffin wax are contained in a weight ratio ranging from about 1:about 0.2 to about 1:about 1. The polycarbonate resin composition is excellent in terms of release properties, transparency, heat resistance, hydrolysis resistance, etc.

### TECHNICAL FIELD

The present invention relates to a polycarbonate resin composition and a molded product produced therefrom. More particularly, the present invention relates to a polycarbonate resin composition having good properties in terms of release performance, transparency, thermal resistance, hydrolysis resistance, and the like, and a molded product produced therefrom.

### BACKGROUND ART

A polycarbonate resin is a representative thermoplastic resin having a heat deflection temperature of about 135° C. or more and is used in various fields including automobile components, electric/electronic products, office machinery, and the like due to good properties thereof in terms of transparency, impact resistance, self-extinction, dimensional stability, thermal resistance, and the like.

However, a polycarbonate resin and a molded product comprising the same have problems of a complicated shape and difficulty in release from a mold in injection molding of a large product.

Conventionally, in order to solve such problems, a release agent is mixed with a polycarbonate resin composition in order to enhance release performance of a molded product of the polycarbonate resin composition.

However, an excess of the release agent can cause deterioration in thermal stability or moist heat stability of the polycarbonate resin composition, generation of a number of gas silver streaks, and increase in yellow index. Moreover, some release agents can deteriorate transparency of the polycarbonate resin composition.

Therefore, there is a need for development of a polycarbonate resin composition having good properties in terms of transparency, thermal resistance, hydrolysis resistance, and balance therebetween even in use of the release agent for the purpose of enhancing release performance.

The background technique of the present invention is disclosed in Japanese Patent Registration No. 5634980 and the like.

### DISCLOSURE

### Technical Problem

It is one object of the present invention to provide a polycarbonate resin composition having good properties in terms of release performance, transparency, thermal resistance, hydrolysis resistance, and the like.

It is one object of the present invention to provide a molded product produced from the polycarbonate resin composition.

The above and other objects of the present invention can be achieved by the present invention described below.

### Technical Solution

One aspect of the present invention relates to a polycarbonate resin composition. The polycarbonate resin composition includes: a polycarbonate resin; and a release agent including a fatty acid ester compound and paraffin wax, wherein the fatty acid ester compound and the paraffin wax are present in a weight ratio of about 1:0.2 to about 1:1.

In some embodiments, the release agent may be present in an amount of about 0.05 to about 1 part by weight relative to about 100 parts by weight of the polycarbonate resin.

In some embodiments, the polycarbonate resin may have weight average molecular weight of about 10,000 g/mol to about 100,000 g/mol.

In some embodiments, the fatty acid ester compound may be an ester compound of pentaerythritol and a C₁₀ to C₃₀ fatty acid.

In some embodiments, the paraffin wax may be a C₂₀ to C₄₀ aliphatic saturated hydrocarbon mixture.

In some embodiments, the polycarbonate resin composition may further include an anthraquinone-based coloring agent.

In some embodiments, the anthraquinone-based coloring agent may be present in an amount of about 0.00001 to about 0.0001 parts by weight relative to about 100 parts by weight of the polycarbonate resin.

In some embodiments, the polycarbonate resin composition may have a release force of about 1,100 N or less applied to an ejector pin upon separation of a specimen of the polycarbonate resin composition from a cup-shaped mold having a diameter of 60 mm and a height of about 3 cm after injection molding the specimen at an injection molding temperature of about 310° C. and a mold temperature of about 65° C.

In some embodiments, the polycarbonate resin composition may have a transmittance of about 90% or more, as measured on an about 2.5 mm thick specimen in accordance with ASTM D1003.

In some embodiments, the polycarbonate resin composition may have a yellow index difference of about 1.7 or less, as calculated according to Equation 1:

ΔYI=YI₁−YI₀, [Equation 1]

in Equation 1, YI₀ is a yellow index of a specimen of the polycarbonate resin composition prepared by injection molding under conditions of an injection molding temperature (cylinder temperature) of about 340° C. and a mold temperature of about 70° C. for a typical cycle time, and YI₁ is a yellow index of a specimen of the polycarbonate resin composition prepared by injection molding under conditions of an injection molding temperature (cylinder temperature) of about 340° C. and a mold temperature of about 70° C. after the polycarbonate resin composition is left in a molten state within a cylinder for about 5 minutes.

In some embodiments, the polycarbonate resin composition may have a weight average molecular weight (Mw) retention rate of about 96% or more, as calculated by Equation 2:

Weight average molecular weight (Mw) retention rate (%)=(MW₁/MW₀)×100, [Equation 2]

in Equation 2, MW₀ is a weight average molecular weight of a specimen of the polycarbonate resin composition, as measured by gel permeation chromatography (GPC) before moist heat evaluation and MW₁ is a weight average molecular weight of a specimen of the polycarbonate resin composition, as measured by GPC after moist heat evaluation (by leaving the specimen under conditions of 120° C. and about 100% relative humidity (RH) for about 16 hours).

Another aspect of the present invention relates to a molded product formed of the polycarbonate resin composition.

### Advantageous Effects

The present invention provides a polycarbonate resin composition having good properties in terms of release performance, transparency, thermal resistance, hydrolysis resistance, and the like, and a molded product comprising the same.

### BEST MODE

Hereinafter, embodiments of the present invention will be described in detail.

A polycarbonate resin composition according to the present invention includes (A) a polycarbonate resin; and (B) a release agent including (B1) a fatty acid ester compound and (B2) paraffin wax.

(A) Polycarbonate Resin

According to embodiments of the present invention, the polycarbonate resin may include any suitable polycarbonate resin such as an aromatic polycarbonate resin used in a typical polycarbonate resin composition. For example, the polycarbonate resin may be prepared by a typical method through reaction of an aromatic dihydroxy compound with a carbonate precursor, such as phosgene, halogen formate, and diester carbonate, in the presence of a catalyst.

In some embodiments, the aromatic dihydroxy compound may include a bis(hydroxyaryl)alkane, a bis(hydroxyaryl)cycloalkane, a bis(hydroxyaryl)ether, a bis(hydroxyaryl)sulfoxide, a bis(hydroxyaryl)sulfide, a bis(hydroxyaryl)sulfone, a biphenyl compound, a dihydroxy benzene compound, and combinations thereof.

Specifically, examples of the bis(hydroxyaryl)alkane may include bis(4-hydroxyphenyl)methane, bis(3-methyl-4-hydroxyphenyl)methane, bis(3-chloro-4-hydroxyphenyl)methane, bis(3,5-dibromo-4-hydroxyphenyl)methane, 1,1-bis(4-hydroxyphenyl)ethane, 1,1-bis(2-tertiary-butyl-4-hydroxy-3-methylphenyl)ethane, 2,2-bis(4-hydroxyphenyl)propane (hereinafter, bisphenol A), 2,2-bis(3-methyl-4-hydroxyphenyl)propane, 2,2-bis(2-methyl-4-hydroxyphenyl)propane, 2,2-bis(3,5-dimethyl-4-hydroxyphenyl)propane, 1,1-bis(2-tertiary-butyl-4-hydroxy-5-methyl)phenyl)propane, 2,2-bis(3-chloro-4-hydroxyphenyl)propane, 2,2-bis(3-fluoro-4-hydroxyphenyl)propane, 2,2-bis(3-bromo-4-hydroxyphenyl)propane, 2,2-bis(3,5-difluoro-4-hydroxyphenyl)propane, 2,2-bis(3,5-dichloro-4-hydroxyphenyl)propane, 2,2-bis(3,5-dibromo-4-hydroxyphenyl)propane, 2,2-bis(4-hydroxyphenyl)butane, 2,2-bis(4-hydroxyphenyl)octane, 2,2-bis(4-hydroxyphenyl) methane, 2,2-bis(4-hydroxy-1-methylphenyl)propane, 1,1-bis(4-hydroxy-tertiary-butylphenyl)propane, 2,2-bis(4-hydroxy-3-bromophenyl)propane, 2,2-bis(4-hydroxy-3,5-dimethylphenyl)propane, 2,2-bis(4-hydroxy-3,5-dimethylphenyl)propane, 2,2-bis(4-hydroxy-3-chlorophenyl)propane, 2,2-bis(4-hydroxy-3,5-dichlorophenyl)propane, 2,2-bis(4-hydroxy-3,5-dibromophenyl)propane, 2,2-bis(4-hydroxy-3,5-dibromophenyl)propane, 2,2-bis(3-bromo-4-hydroxy-5-chlorophenyl)propane, 2,2-bis(3-phenyl-4-hydroxyphenyl)propane, 2,2-bis(4-hydroxyphenyl)butane, 2,2-bis(3-methyl-4-hydroxyphenyl)butane, 1,1-bis(2-butyl-4-hydroxy-5-methylphenyl)butane, 1,1-bis(2-tertiary-butyl-4-hydroxy-5-methylphenyl)butane, 1,1-bis(2-tertiary-butyl-4-hydroxy-5-methylphenyl)isobutane, 1,1-bis(2-tertiary-amyl-4-hydroxy-5-methylphenyl)butane, 2,2-bis(3,5-dichloro-4-hydroxyphenyl)butane, 2,2-bis(3,5-dibromo-4-phenyl)butane, 4,4-bis(4-hydroxyphenyl)heptane, 1,1-bis(2-tertiary-butyl-4-hydroxy-5-methylphenyl)heptane, 2,2-bis(4-hydroxyphenyl)octane, and 1,1-(4-hydroxyphenyl)ethane, without being limited thereto

Specifically, examples of the bis(hydroxyaryl)cycloalkane may include 1,1-bis(4-hydroxyphenyl)cyclopentane, 1,1-bis(4-hydroxyphenyl)cyclohexane, 1,1-bis(3-methyl-4-hydroxyphenyl)cyclohexane, 1,1-bis(3-cyclohexyl-4-hydroxyphenyl)cyclohexane, 1,1-bis(3-phenyl-4-hydroxyphenyl)cyclohexane, and 1,1-bis(4-hydroxyphenyl)-3,5,5-trimethylcyclohexane, without being limited thereto

Specifically, examples of the bis(hydroxyaryl)ether may include bis(4-hydroxyphenyl)ether, bis(4-hydroxy-3-methylphenyl)ether, and the like; examples of the bis(hydroxyaryl)sulfide may include bis(4-hydroxyphenyl)sulfide, bis(3-methyl-4-hydroxyphenyl)sulfide, and the like; examples of the bis(hydroxyaryl)sulfoxide may include bis(hydroxyphenyl)sulfoxide, bis(3-methyl-4-hydroxyphenyl)sulfoxide, bis(3-phenyl-4-hydroxyphenyl)sulfoxide, and the like; examples of the bis(hydroxyaryl)sulfone may include bis(4-hydroxyphenyl)sulfone, bis(3-methyl-4-hydroxyphenyl)sulfone, bis(3-phenyl-4-hydroxyphenyl)sulfone, and the like; and examples of the biphenyl compound may include 4,4′-dihydroxy biphenyl, 4,4′-dihydroxy-2,2′-dimethylbiphenyl, 4,4′-dihydroxy-3,3 dimethylbiphenyl, and 3,3-difluoro-4,4′-dihydroxybiphenyl, without being limited thereto

Specifically, examples of the dihydroxy benzene compound may include resorcinol, 3-methylresorcinol, 3-ethylresorcinol, 3-propylresorcinol, 3-butylresorcinol, 3-tertiary-butylresorcinol, 3-phenylresorcinol, 2,3,4,6-tetrafluororesorcinol, 2,3,4,6-tetrabromoresorcinol, catechol, hydroquinone, 3-methylhydroquinone, 3-ethylhydroquinone, 3-propylhydroquinone, 3-butylhydroquinone, 3-tertiary-butylhydro quinone, 3-phenylhydroquinone, 3-cumylhydroquinone, 2,5-dichlorohydroquinone, 2,3,5,6-tetramethylhydroquinone, 2,3,5,6-tetra-tertiary-butylhydroquinone, 2,3,5,6-tetrafluorohydroquinone, and 2,3,5,6-tetrabromohydroquinone, without being limited thereto

In some embodiments, the carbonate precursor may include dimethyl carbonate, diethyl carbonate, dibutyl carbonate, dicyclohexyl carbonate, diphenyl carbonate, ditolyl carbonate, bis(chlorophenyl) carbonate, m-cresyl carbonate, dinaphthyl carbonate, carbonyl chloride (phosgene), diphosgene, triphosgene, carbonyl bromide, bishaloformate, and the like. These may be used alone or as a mixture thereof.

In some embodiments, the polycarbonate resin may be prepared by reacting the aromatic dihydroxy compound with the carbonate precursor in a mole ratio of about 1:0.9 to about 1:1.5.

In some embodiments, the polycarbonate resin may be partially or completely replaced by an aliphatic polycarbonate resin, an aromatic and aliphatic copolycarbonate resin, a polyester carbonate resin, a polycarbonate-polysiloxane copolymer resin, or combinations thereof, without being limited to the aromatic polycarbonate resin.

In addition, the polycarbonate resin may be a linear polycarbonate resin, a branched polycarbonate resin, or a combination thereof. For example, the branched polycarbonate resin may be prepared by adding about 0.05 to about 2 mol % of a trivalent or higher polyfunctional compound, specifically, a compound containing a trivalent or higher phenol group relative to the total amount of an (aromatic) dihydroxy compound used in polymerization.

In some embodiments, the polycarbonate resin may have a weight average molecular weight (Mw) of about 10,000 g/mol to about 100,000 g/mol, for example, about 15,000 g/mol to about 80,000 g/mol, as measured by gel permeation chromatography (GPC). Within this range, the polycarbonate resin composition can have good mechanical properties, processability, and the like.

(B) Release Agent

According to embodiments of the present invention, the release agent serves to enhance release performance of the polycarbonate resin composition without deterioration in transparency, thermal resistance, hydrolysis resistance, and the like, and may include the fatty acid ester compound (B1) and the paraffin wax (B2) in a weight ratio (B1:B2) of about 1:0.2 to about 1:1, for example, about 1:0.5 to about 1:1. If the weight ratio of the fatty acid ester compound to the paraffin wax is less than about 1:0.2, the polycarbonate resin composition can suffer from deterioration in thermal resistance and hydrolysis resistance, and if the weight ratio thereof exceeds about 1:1, the polycarbonate resin composition can obtain insignificant improvement in release performance.

(B1) Fatty Acid Ester Compound

According to embodiments of the present invention, the fatty acid ester compound may be an ester compound of a polyhydric alcohol, such as pentaerythritol and stearyl alcohol, or a monohydric alcohol and a C₁₀ to C₃₀ fatty acid.

In some embodiments, the C₁₀ to C₃₀ fatty acid may include capric acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic heptanoic acid, heptacosylic acid, montanic acid, and melissic acid, without being limited thereto. For example, stearic acid may be used.

In some embodiments, the fatty acid ester compound may include pentaerythritol tetrastearate, pentaerythritol monostearate, and stearyl stearate, without being limited thereto. For example, pentaerythritol tetrastearate may be used.

(B2) Paraffin Wax

According to embodiments of the present invention, the paraffin wax may be a natural oil-based wax and may include a C₂₀ to C₄₀ aliphatic saturated hydrocarbon mixture in a solid phase.

In some embodiments, the release agent (B) may be present in an amount of about 0.05 to about 1 part by weight, for example, about 0.1 to about 0.5 parts by weight, relative to about 100 parts by weight of the polycarbonate resin (A). Within this range, the polycarbonate resin composition can have good properties in terms of release performance, transparency, thermal resistance, hydrolysis resistance, and balance therebetween.

In some embodiments, the polycarbonate resin composition may further include an anthraquinone-based coloring agent in order to improve transparency and color.

In some embodiments, the anthraquinone-based coloring agent may be a blue color-based anthraquinone compound, which can change yellow color of the polycarbonate resin composition. For example, the blue color-based anthraquinone compound may include a compound represented by Formula 1, a compound represented by Formula 2, a compound represented by Formula 3, a compound represented by Formula 4, and combinations thereof, without being limited thereto.

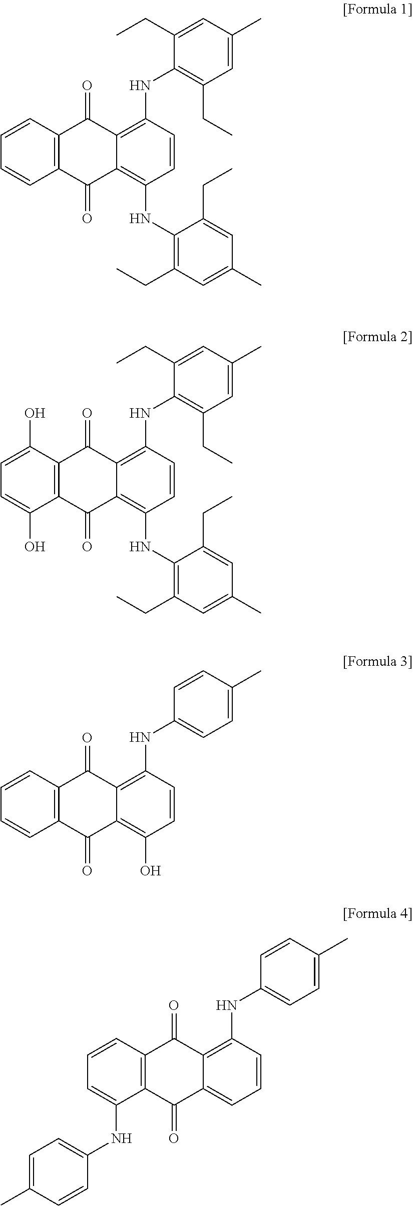

In some embodiments, the anthraquinone-based coloring agent may be present in an amount of about 0.00001 to about 0.0001 parts by weight, for example, about 0.00004 to about 0.0001 parts by weight, relative to about 100 parts by weight of the polycarbonate resin. Within this range, the polycarbonate resin composition can have improved transparency and color without deterioration in other properties.

In some embodiments, the polycarbonate resin composition may further include typical additives, as needed. Examples of the additives may include flame retardants, fillers, antioxidants, anti-dripping agents, lubricants, release agents, nucleating agents, antistatic agents, stabilizers, coloring agents (pigments and/or dyes) other than the anthraquinone-based coloring agent, and mixtures thereof, without being limited thereto. The additive may be present in an amount of about 0.0001 to about 20 parts by weight relative to about 100 parts by weight of the polycarbonate resin, without being limited thereto.

According to embodiments of the present invention, the polycarbonate resin composition may have a release force of about 1,100 N or less, for example, about 1,000 N to about 1,100 N, applied to an ejector pin upon separation of a specimen of the polycarbonate resin composition from a cup-shaped mold having a diameter of 60 mm and a height of about 3 cm after injection molding the specimen at an injection molding temperature of about 310° C. and a mold temperature of about 65° C. Here, a lower release force indicates better release performance.

In some embodiments, the polycarbonate resin composition may have a transmittance of about 90% or more, for example, about 90% to about 98%, as measured on an about 2.5 mm thick specimen in accordance with ASTM D1003.

In some embodiments, the polycarbonate resin composition may have a yellow index difference of about 1.7 or less, for example, about 0.5 to about 1.7, as calculated according to Equation 1:

ΔYI=YI₁−YI₀, [Equation 1]

in Equation 1, YI₀ is a yellow index of a specimen of the polycarbonate resin composition prepared by injection molding under conditions of an injection molding temperature (cylinder temperature) of about 340° C. and a mold temperature of about 70° C. for a typical cycle time, and YI₁ is a yellow index of a specimen of the polycarbonate resin composition prepared by injection molding under conditions of an injection molding temperature (cylinder temperature) of about 340° C. and a mold temperature of about 70° C. after the polycarbonate resin composition is left in a molten state within a cylinder for about 5 minutes.

In some embodiments, the polycarbonate resin composition may have a weight average molecular weight (Mw) retention rate of about 96% or more, for example, about 96% to about 99.9%, as calculated by Equation 2:

Weight average molecular weight (Mw) retention rate (%)=(MW₁/MW₀)×100, [Equation 2]

in Equation 2, MW₀ is a weight average molecular weight of a specimen of the polycarbonate resin composition, as measured by gel permeation chromatography (GPC) before moist heat evaluation and MW₁ is a weight average molecular weight of a specimen of the polycarbonate resin composition, as measured by gel permeation chromatography (GPC) after moist heat evaluation (by leaving the specimen under conditions of 120° C. and about 100% relative humidity (RH) for about 16 hours).

A molded product according to the present invention is produced from the polycarbonate resin composition. The polycarbonate resin composition according to the embodiments of the present invention may be prepared by any known method for preparing a polycarbonate resin composition. For example, the aforementioned components and, optionally, other additives are mixed, followed by melt extrusion in an extruder, thereby preparing a polycarbonate resin composition in pellet form. The prepared pellets may be produced into various molded products (products) by various molding methods, such as injection molding, extrusion molding, vacuum molding, and casting. Such molding methods are well known to those skilled in the art. The molded product according to the present invention exhibits good properties in terms of release performance, transparency, thermal resistance, hydrolysis resistance, and balance therebetween, and thus can be advantageously applied to various fields such as interior/exterior materials for electric/electronic products and the like, particularly a product having difficulty in molding due to a large size and a complicated shape thereof, such as chairs.

### MODE FOR INVENTION

Next, the present invention will be described in more detail with reference to some examples. It should be understood that these examples are provided for illustration only and are not to be construed in any way as limiting the present invention.

### EXAMPLE

Details of components used in Examples and Comparative Examples are as follows.

(A) Polycarbonate Resin

A bisphenol-A type polycarbonate resin (Manufacturer: Teijin Co., Ltd., Product Name: L-1250WP) was used.

(B) Release Agent

(B1) Pentaerythritol tetrastearate (Manufacturer: NOF Co., Ltd.) was used.

(B2) Paraffin wax (Manufacturer: Nippon Seiro Co., Ltd.) was used.

(B3) Polyethylene oxide wax (Manufacturer: Emery Oleochemicals Co., Ltd.) was used.

(C) Anthraquinone-Based Coloring Agent

Blue anthraquinone-based coloring agent (Manufacturer: Lanxess Co., Ltd., Product Name: Macrolex blue RR) was used.

### Examples 1 to 6 and Comparative Examples 1 to 6: Preparation of Polycarbonate Resin Composition

According to the compositions and contents as listed in Tables 1 and 2, the above components were placed in a twin-screw extruder (L/D=35, diameter: 45 mm) and subjected to melt-extrusion at a temperature of 260° C. to 300° C. and a screw speed of 150 rpm to 350 rpm, thereby preparing pellets. The pellets were dried at 120° C. for 4 hours or more and injection-molded in an injection molding machine (DHC 120WD, Dongshin Hydraulic Pressure Co., Ltd., 120 ton) at a molding temperature of 290° C. to 340° C. and a mold temperature of 65° C. to 70° C., thereby preparing specimens. The prepared specimens were evaluated as to the following properties by the following method, and results are shown in Table 1.

Property Evaluation

(1) Release force (unit: N): Release force applied to an ejector pin upon separation of a specimen from a cup-shaped mold having a diameter of 60 mm and a height of about 3 cm was measured after injection molding the specimen at an injection molding temperature of about 310° C. and a mold temperature of about 65° C.

(2) Transmittance (unit: %): Total light transmittance (TT) was measured on a 2.5 mm thick specimen using a haze meter (NDH 5000W, Nippon Denshoku Co., Ltd.) in accordance with ASTM D1003.

(3) Thermal resistance: Yellow index difference (ΔYI) was calculated according to Equation 1. A lower difference in yellow index indicates better thermal resistance.

ΔYI=YI₁−YI₀, [Equation 1]

in Equation 1, YI₀ is a yellow index of a specimen of the polycarbonate resin composition prepared by injection molding under conditions of an injection molding temperature (cylinder temperature) of about 340° C. and a mold temperature of about 70° C. for a typical cycle time, and YI₁ is a yellow index of a specimen of the polycarbonate resin composition prepared by injection molding under conditions of an injection molding temperature (cylinder temperature) of about 340° C. and a mold temperature of about 70° C. after the polycarbonate resin composition is left in a molten state within a cylinder for about 5 minutes. Here, each yellow index was measured using a colorimeter (ND-1001 DP, Nippon Denshoku Co., Ltd.) in accordance with ASTM D1925.

(4) Hydrolysis resistance (Moist heat evaluation): Weight average molecular weight retention rate (unit: %) was calculated according to Equation 2. A higher weight average molecular weight retention rate indicates better hydrolysis resistance.

Weight average molecular weight (Mw) retention rate (%)=(MW₁/MW₀)×100, [Equation 2]

in Equation 2, MW₀ is a weight average molecular weight of a specimen of the polycarbonate resin composition, as measured by gel permeation chromatography (GPC) before moist heat evaluation and MW₁ is a weight average molecular weight of a specimen of the polycarbonate resin composition, as measured by GPC after moist heat evaluation (by leaving the specimen under condition of 120° C. and about 100% relative humidity (RH) for about 16 hours).

(5) Brightness: Brightness (L*) was measured on a 2.5 mm thick specimen of the polycarbonate resin composition using a colorimeter (ND-1001 DP, Nippon Denshoku Co., Ltd.) in accordance with ASTM D2244.

TABLE 1

| | | Example | | | | | |
|---|---|---|---|---|---|---|---|
| | | 1 | 2 | 3 | 4 | 5 | 6 |
| (A) (parts by weight) | | 100 | 100 | 100 | 100 | 100 | 100 |
| (B) | (B1) | 0.2 | 0.2 | 0.15 | 0.25 | 0.25 | 0.15 |
| (parts by weight) | (B2) | 0.1 | 0.1 | 0.15 | 0.05 | 0.05 | 0.15 |
| | (B3) | — | — | — | — | — | — |

| | | | | | | |
|---|---|---|---|---|---|---|
| (B1):(B2) (weight ratio) | 1:0.5 | 1:0.5 | 1:1 | 1:0.2 | 1:0.2 | 1:1 |
| (C) (parts by weight) | 0.00004 | 0.00009 | 0.00004 | 0.00004 | — | — |
| Release force (N) | 1,100 | 1,100 | 1,060 | 1,010 | 1,010 | 1,060 |
| Transmittance (%) | 90.4 | 90.1 | 90.1 | 90.2 | 90.3 | 90.1 |
| Yellow index difference (ΔYI) | 1.5 | 1.5 | 1.5 | 1.4 | 1.4 | 1.5 |
| Mw retention rate (%) | 96.8 | 96.4 | 97.2 | 97.8 | 97.8 | 97.2 |
| Brightness (L*) | 98.5 | 98.3 | 98.4 | 98.4 | 97.8 | 97.7 |
| Yellow index (YI₀) | −0.0 | −1.1 | −0.1 | −0.0 | 1.2 | 1.1 |

TABLE 2

| | | Comparative Example | | | | | |
|---|---|---|---|---|---|---|---|
| | | 1 | 2 | 3 | 4 | 5 | 6 |
| (A) (parts by weight) | | 100 | 100 | 100 | 100 | 100 | 100 |
| (B) | (B1) | 0.3 | — | 0.1 | 0.2 | — | — |
| (parts by weight) | (B2) | — | 0.3 | 0.2 | — | 0.2 | — |
| | (B3) | — | — | — | 0.1 | 0.1 | 0.3 |

| | | | | | | |
|---|---|---|---|---|---|---|
| (B1):(B2) (weight ratio) | 1:0 | 0:1 | 1:2 | — | — | — |
| (C) (parts by weight) | 0.00006 | 0.00006 | 0.00004 | 0.00004 | 0.00004 | 0.0006 |
| Release force (N) | 1,330 | 1,310 | 1,281 | 1,205 | 1,150 | 1,100 |
| Transmittance (%) | 89.1 | 90.0 | 90.2 | 87.9 | 88.0 | 86.1 |
| Yellow index difference (ΔYI) | 1.8 | 1.5 | 1.6 | 1.7 | 1.5 | 1.4 |
| Mw retention rate (%) | 94.1 | 97.5 | 97.0 | 93.9 | 94.6 | 93.4 |
| Brightness (L*) | 97.1 | 97.3 | 97.1 | 97.0 | 97.1 | 97.0 |
| Yellow index (YI₀) | −0.2 | −0.1 | 0.1 | 0.0 | 0.1 | −0.2 |

From the above results, it could be seen that the polycarbonate resin compositions according to the present invention had good properties in terms of release performance, transparency, thermal resistance, hydrolysis resistance, and balance therebetween.

Conversely, it could be seen that the polycarbonate resin compositions prepared using only one type of release agent (Comparative Examples 1 and 2) and the polycarbonate resin composition prepared using a mixture of 2 types of release agents in a weight ratio deviating from the inventive range (Comparative Example 3) suffered from deterioration in release performance and thermal resistance, as compared with the polycarbonate resin compositions (Examples) according to the present invention. Further, it could be seen that the polycarbonate resin composition prepared using different types of release agents from those of the polycarbonate resin composition according to the present invention (Comparative Examples 4 to 6) suffered from deterioration in transmittance, hydrolysis resistance, and the like.

It should be understood that various modifications, changes, alterations, and equivalent embodiments, can be made by those skilled in the art without departing from the spirit and scope of the invention.

1. A polycarbonate resin composition comprising:
a polycarbonate resin; and
a release agent comprising a fatty acid ester compound and paraffin wax,
wherein the fatty acid ester compound and the paraffin wax are present in a weight ratio of about 1:0.2 to about 1:1.

2. The polycarbonate resin composition according to claim 1, wherein the release agent is present in an amount of about 0.05 to about 1 part by weight relative to about 100 parts by weight of the polycarbonate resin.

3. The polycarbonate resin composition according to claim 1, wherein the polycarbonate resin has a weight average molecular weight of about 10,000 g/mol to about 100,000 g/mol.

4. The polycarbonate resin composition according to claim 1, wherein the fatty acid ester compound is an ester compound of pentaerythritol and a C₁₀ to C₃₀ fatty acid.

5. The polycarbonate resin composition according to claim 1, wherein the paraffin wax is a C₂₀ to C₄₀ aliphatic saturated hydrocarbon mixture.

6. The polycarbonate resin composition according to claim 1, further comprising: an anthraquinone-based coloring agent.

7. The polycarbonate resin composition according to claim 6, wherein the anthraquinone-based coloring agent is present in an amount of about 0.00001 to about 0.0001 parts by weight relative to about 100 parts by weight of the polycarbonate resin.

8. The polycarbonate resin composition according to claim 1, wherein the polycarbonate resin composition has a release force of about 1,100 N or less applied to an ejector pin upon separation of a specimen of the polycarbonate resin composition from a cup-shaped mold having a diameter of 60 mm and a height of about 3 cm after injection molding the specimen at an injection molding temperature of about 310° C. and a mold temperature of about 65° C.

9. The polycarbonate resin composition according to claim 1, wherein the polycarbonate resin composition has a transmittance of about 90% or more, as measured on an about 2.5 mm thick specimen in accordance with ASTM D1003.

10. The polycarbonate resin composition according to claim 1, wherein the polycarbonate resin composition has a yellow index difference of about 1.7 or less, as calculated according to Equation 1:
ΔYI=YI₁−YI₀, [Equation 1]
in Equation 1, YI₀ is a yellow index of a specimen of the polycarbonate resin composition prepared by injection molding under conditions of an injection molding temperature (cylinder temperature) of about 340° C. and a mold temperature of about 70° C. for a typical cycle time, and YI₁ is a yellow index of a specimen of the polycarbonate resin composition prepared by injection molding under conditions of an injection molding temperature (cylinder temperature) of about 340° C. and a mold temperature of about 70° C. after the polycarbonate resin composition is left in a molten state within a cylinder for about 5 minutes.

11. The polycarbonate resin composition according to claim 1, wherein the polycarbonate resin composition has a weight average molecular weight (Mw) retention rate of about 96% or more, as calculated by Equation 2:
Weight average molecular weight (Mw) retention rate (%)=(MW₁/MW₀)×100, [Equation 2]
in Equation 1, MW₀ is a weight average molecular weight of a specimen of the polycarbonate resin composition, as measured by gel permeation chromatography (GPC) before moist heat evaluation, and MW₁ is a weight average molecular weight of a specimen of the polycarbonate resin composition, as measured by GPC after moist heat evaluation (by leaving the specimen under condition of 120° C. and about 100% RH for about 16 hours).

12. A molded product produced from the polycarbonate resin composition according to claim 1.
